(19) United States
(12) Patent Application Publication
(10) Pub. No.: US 2024/0287838 A1
(43) Pub. Date: Aug. 29, 2024

(54) SYSTEMS AND METHODS OF SECURING A PORTAL

(71) Applicant: Jamie Lynne Miller, Virginia Beach, VA (US)

(72) Inventor: Charles James Miller, II, Virginia Beach, VA (US)

(21) Appl. No.: 18/441,006

(22) Filed: Feb. 14, 2024

Related U.S. Application Data
(60) Provisional application No. 63/445,328, filed on Feb. 14, 2023.

(51) Int. Cl. E05C 19/18; E05B 17/10; E05B 47/00; E05C 17/36

(52) U.S. Cl. CPC E05C 19/184; E05B 17/10; E05B 2047/0067; E05C 17/365

(57) ABSTRACT

Systems and methods of securing a portal are provided. In one exemplary embodiment, a portal securing system includes a permanent or semi-permanent component and a transportable component. The permanent or semi-permanent component includes at least one anchor element, with each anchor element being configured to attach to a wall or frame associated with a portal. The transportable component includes a longitudinal element coupled to a coupling mechanism, with the transportable component having at least a certain minimum breaking load. Further, the longitudinal element has first and second ends, with each end having a loop or lariat assembly. The portal securing system is operable to prevent the portal from being opened while the transportable component is securely coupled between the permanent or semi-permanent component and a locking mechanism of the portal.

### CROSS REFERENCE TO RELATED APPLICATIONS

The present application claims the benefit of U.S. Provisional App. No. 63/445,328, filed Feb. 14, 2023, which is hereby incorporated by reference in its entirety.

### FIELD OF DISCLOSURE

The present disclosure relates generally to the field of lock mechanisms, and in particular, the present disclosure relates to systems and methods of securing a portal.

### BACKGROUND

We live in a world today in which it is all too common to see violent acts committed against individuals in a public setting (e.g., school, church, work, campus, dorms). Sadly, many of these violent acts have resulted in individuals including children being killed or severely injured by intruders armed with knives or guns. Often, the only defense these individuals have is to lock or barricade themselves behind a door in hopes that the intruder cannot enter the room. In these tragic situations, the standard locking mechanism of a door or window may not be sufficient to keep an intruder from entering the room.

Accordingly, there is a need for a portal securing system that is affordable, easily and quickly attachable to secure a portal and not easily accessible or removable by an intruder once attached. In addition, other desirable features and characteristics of the present disclosure will become apparent from the subsequent detailed description and embodiments, taken in conjunction with the accompanying figures and the foregoing technical field and background.

The Background section of this document is provided to place embodiments of the present disclosure in technological and operational context, to assist those of skill in the art in understanding their scope and utility. Unless explicitly identified as such, no statement herein is admitted to be prior art merely by its inclusion in the Background section.

### BRIEF DESCRIPTION OF THE DRAWINGS

The present disclosure will now be described more fully hereinafter with reference to the accompanying drawings, in which embodiments of the disclosure are shown. However, this disclosure should not be construed as limited to the embodiments set forth herein. Rather, these embodiments are provided so that this disclosure will be thorough and complete, and will fully convey the scope of the disclosure to those skilled in the art. Like numbers refer to like elements throughout.

FIG. 1 illustrates a perspective view of one embodiment of a transportable component of a portal securing system disposed in a storage device in accordance with various aspects as disclosed herein.

FIG. 2 illustrates a perspective view of one embodiment of a portal securing system disposed on an inwardly swinging portal in accordance with various aspects as described herein.

FIG. 3 illustrates a perspective view of another embodiment of a portal securing system disposed on an inwardly swinging portal and wall in accordance with various aspects as described herein.

FIG. 4 illustrates a top view of the portal securing system of FIG. 3 with the inwardly swinging portal being slightly ajar while secured by the portal securing system.

FIG. 5 illustrates a perspective view of another embodiment of a portal securing system disposed on an outwardly swinging portal and wall in accordance with various aspects as described herein.

FIG. 6 illustrates a top view of the portal securing system of FIG. 5 with the outwardly swinging portal being slightly ajar while secured by the portal securing system.

FIG. 7A illustrates one embodiment of an illumination assembly in accordance with various aspects as described herein. FIG. 7B illustrates one embodiment of an electromechanical system of the illumination assembly of FIG. 7A.

FIGS. 8A-B illustrate other embodiments of a transportable component in accordance with various aspects as described herein.

FIG. 9 illustrates another embodiment of an illumination assembly in accordance with various aspects as described herein.

### DETAILED DESCRIPTION

For simplicity and illustrative purposes, the present disclosure is described by referring mainly to exemplary embodiments thereof. In the following description, numerous specific details are set forth in order to provide a thorough understanding of the present disclosure. However, it will be readily apparent to one of ordinary skill in the art that the present disclosure may be practiced without limitation to these specific details.

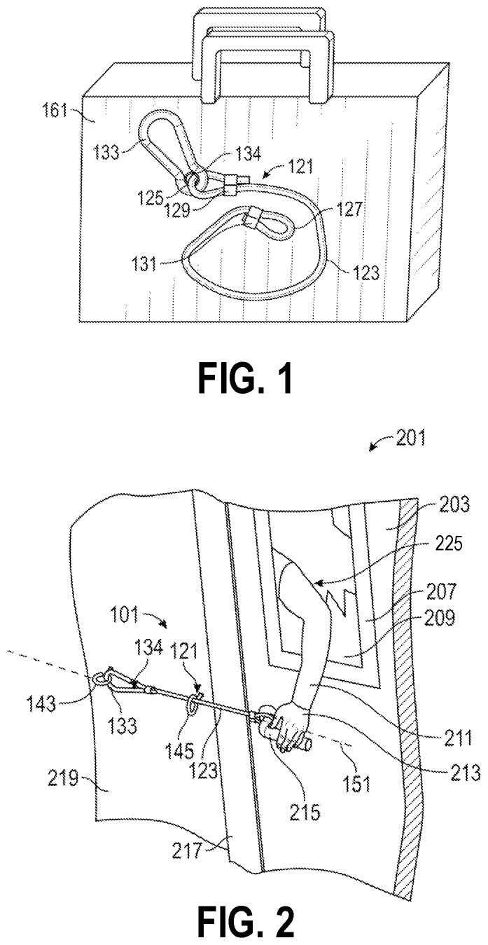

The present disclosure relates to a portal securing system that can be used to secure a portal (e.g., door, window) that is operable to open to the outside or inside, up or down, left or right, or the like. In particular, a portal securing system and method of use described herein can be used to secure a portal from being opened by an intruder. For example, referring now to FIGS. 1-6, there is shown exemplary embodiments of systems of securing a portal 203, 204 (e.g., door, window) of a portal assembly 201 (e.g., door assembly, window assembly), which generally comprises a portal securing system 101 having a transportable component 121 and a permanent or semi-permanent component. For example, FIG. 1 illustrates a perspective view of one embodiment of a transportable component 121 of the portal securing system 101 disposed in a storage device 161 in accordance with various aspects as disclosed herein. The portal securing system 101 is operable to withstand repeated attempts to open the portal 203, 204 by a determined intruder 225. Further, the transportable component 121 can include a longitudinal element 123 (e.g., chain, wire, or the like) having a minimum breaking load that corresponds to withstanding repeated attempts to open the portal 203, 204 by a determined intruder 225. In one embodiment, the minimum breaking load of the longitudinal element 123 is at least one hundred MegaPascals (100 MPa), in another embodiment is at least two hundred MegaPascals (200 MPa), in another embodiment is at least three hundred MegaPascals (300 MPa), in another embodiment is at least four hundred MegaPascals (400 MPa), and in another embodiment is at least five hundred MegaPascals (500 MPa). Further, the transportable component 121 can be flexible so as to be formed or shaped for storage in the storage device 161. The portal assembly 201 can include the portal 203, 204, a locking mechanism 215 (e.g., door handle, window lock), a window 207 having a glass insert 209, a portal frame 217 (e.g., door frame, window frame), the like, or any combination thereof.

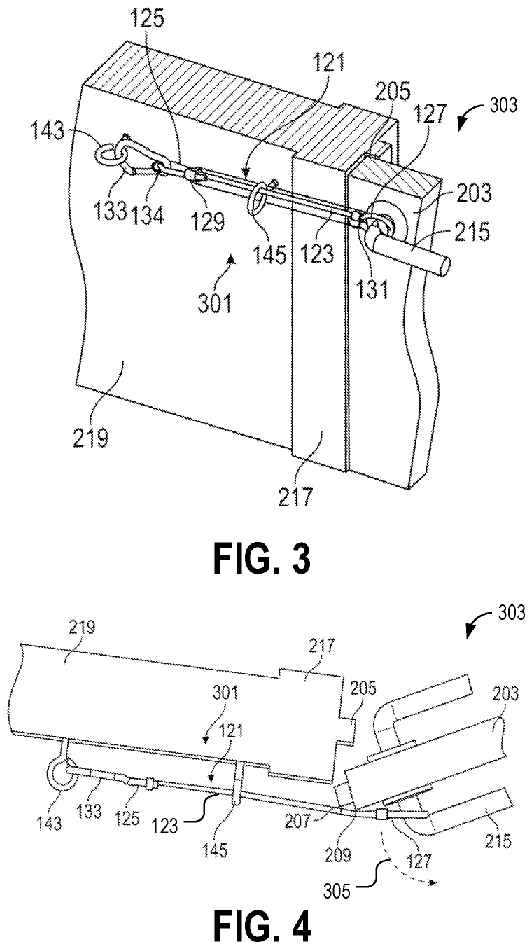

The permanent or semi-permanent component can include at least one anchor element 143, 145 (e.g., eye hook screw, molly bolt, toggle bolt, anchor). Each anchor element 143, 145 is operable to be attached to the wall 219 or another surface. As such, as shown in FIG. 3, a first anchor element 143 is disposed in the wall 219 away from and parallel to the locking mechanism 215 of the portal 203 with a second anchor element 145 disposed in the wall 219 adjacent to portal frame 217 or on the portal frame 217. Further, the second anchor element 145 may be aligned along an axis 151 between the first anchor element 143 and the locking mechanism 215. In one example, the first and second anchor elements 143, 145 are metal screw eye hooks with the first anchor element 143 being attached to the wall 219 such that the eye is parallel to the axis 151 and the second anchor element 145 being attached to the wall 219 or the portal frame 217 such that the eye is perpendicular to the axis 151. A skilled artisan will readily recognize techniques for securing the permanent or semi-permanent component to a wall, portal frame, or the like.

In FIG. 1, there is illustrated one embodiment of the transportable component 121 of the portal securing system 101 according to the present disclosure and available for quick deployment when needed. As shown in FIG. 1, the transportable component 121 is transportable such as by storage device 161 (e.g., briefcase, drawer, box, bag) and can include the longitudinal element 123 having loop or lariat assemblies 125, 127 formed at each end of the longitudinal element 123. In one example, each loop or lariat assembly 125, 127 can be configured by forming a loop or lariat with an end portion of the longitudinal element 123 and then securely attaching a fastener element 129, 131 about a base of each loop or lariat assembly 125, 127 to secure the loop or lariat of that end portion to the longitudinal element 123. At least one loop or lariat assembly 125, 127 can be actively adapted to be placed over any locking mechanism 215 or similar protrusion disposed on the portal 203 and then positioned at the base of the locking mechanism 215, where that loop or lariat assembly 125, 127 can also be actively adapted to be loosened so as to be applied or removed from the locking mechanism 215 and to be tightened so as to be tightened to the locking mechanism 215. In one example, the loop or lariat assembly 127 is configured as a lariat so that the lariat can be tightened or loosened. The lariat assembly 125, 127 is operable to be loosened prior to being disposed over the locking mechanism 215 (e.g., a typical door knob or handle or window opening device) and then tightened to secure the lariat to the base of the locking mechanism 215. Each loop or lariat assembly 125, 127 can also be configured such that it can be threaded through an eye of the anchor element 143, 145. A coupling device 133 (e.g., carabineer) is configured to include an eyelet mechanism or element 134 that enables the coupling device 133 to be securely coupled to the loop or lariat assembly 125 so that the coupling device 133 is securely coupled to the longitudinal element 123.

The longitudinal element 123 can be composed of a metal (e.g., steel, stainless steel, another metal or alloy). Further, the longitudinal element 123 can be composed of natural or synthetic fibers such as hemp, linen, cotton, coir, jute, straw, sisal, polypropylene, nylon, polyesters (e.g., polyethylene terephthalate, liquid crystal polymer, high density polyethylene, Vectran®), polyethylene (e.g., Dyneema® and Spectra®), aramids (e.g., Twaron®, Technora® and Kevlar®) and acrylics (e.g. Dralon®), the like, or any combination thereof. The longitudinal element 123 can also be composed of a wire rope that includes stranded or spiral wires or cables. The longitudinal element 123 can be in one embodiment in a range of about 6″ to about 12″, in another embodiment in a range from about 6″ to about 24″, in another embodiment in a range from about 6″ to about 36″, and in another embodiment in a range from about 6″ to about 48″. In another example, the length of the longitudinal element 123 is about 27″ to about 28″.

Each fastener element 129, 131 can be composed of a metal or metal alloy material. In one example, each fastener element 129, 131 is configured as a metal or metal alloy material that is crimped onto the longitudinal element 123 to form the loop or lariat assembly 125, 127. In another example, each fastener element 129, 131 is composed of steel or stainless steel. In yet another example, each fastener element 129, 131 can include a thimble, a wire rope clamp or clip, a swaged or wedge socket, a potted or poured socket, an eye splice, the like, or any combination thereof.

The coupling device 133 can be a spring-loaded coupling device that enables easy attachment to the first anchor element 143. The coupling device 133 is configured to couple the longitudinal element 123 and the first anchor element 143. A spring-loaded coupling device can be operable to both releasably attach and detach the longitudinal element 123 and the first anchor element 143. This active engagement of the spring-loaded coupling device 133 to the first anchor element 143 avoids accidental detachment of the spring loaded coupling device from the first anchor element 143. In addition, an intruder would have to actively actuate the spring-loaded coupling device to decouple from the first anchor element 143. The first anchor element 143 can be positioned on the wall 219 so that an intruder would not be able to reach and decouple the coupling device 133 from the first anchor element 143 or the first anchor element 143. In another example, the coupling device 133 is a carabineer. In yet another example, the coupling device 133 is a hook or clasp. The coupling device 133 and the anchor elements 143, 145 can be water-resistant, light weight, malleable, oxidation resistant, or other beneficial characteristic understood by one skilled in the art.

The longitudinal element 123 can have the second loop or lariat assembly 127 removably attached to the portal or locking mechanism 215 and the first loop or lariat assembly 125 threaded through the second anchor element 145 anchored into the wall 219 or in the portal frame 217 and then removably attached to the first anchor element 143 anchored to the wall 219 through the coupling device 133, with the coupling device 133 being attached to the first loop assembly 125 of the longitudinal element 123. The first and second anchor elements 143, 145, which in some embodiments are eye bolts, are arranged to be substantially parallel to the locking mechanism 215 of the portal assembly 201.

In another embodiment, the first and second anchor elements 143, 145 are offset from each other by a certain distance that can be up to about half the length of the longitudinal element 123. In another embodiment, the first and second anchor elements 143, 145 are positioned on the wall 219 such that when the longitudinal element 123 is taught the longitudinal element 123 forms a shape of a “V” (in any angular orientation) with the second anchor element 145 positioned at the vertex of the formed “V” shape and the first anchor element 143 and the locking mechanism 215 at the end of each corresponding ray of the formed “V” shape.

In another embodiment, the first anchor element 143 and the locking mechanism 215 are about equidistant from the second anchor element 145.

In another embodiment, the second anchor element 145 is attached to the wall 219 or the frame 217 a certain distance from the locking mechanism 215. The first anchor element 143 can be attached to the wall about an integer multiple of that certain distance away from the second anchor element 145.

In another embodiment, the first fastener anchor 143 is attached to the wall 219 about 27″ to about 28″ from the locking mechanism 215, and the second anchor element 145 is attached to the wall 219 or the frame 217 about 6″ to about 10″ away from the locking mechanism 215.

In another embodiment, a third anchor element (not shown) is attached on the wall 219 between the first and second anchor elements 143, 145.

In another embodiment, the portal securing system 101 is operable to prevent the portal 201 from opening both inwards and outwards, upwards and downwards, or left and right. In particular, the portal securing system 101 is effective in preventing an inward or outward swinging portal 203, 204 or a vertically or horizontally moving portal window from being unwantedly open. While an inwardly swinging portal can be barricaded from within the corresponding room, an outwardly swinging portal cannot be barricaded from within the corresponding room.

FIG. 2 illustrates a perspective view of one embodiment of a portal securing system 101 disposed on an inwardly swinging portal assembly 201 in accordance with various aspects as described herein. In FIG. 2, the portal assembly 201 includes a portal 203, a window 207 having a glass insert 209, a locking mechanism 215, a portal frame 217, the like, or any combination thereof. The portal securing system 101 can be installed on the portal 203 without having to open the portal 203 or having to step through the portal frame 217. As such, the portal securing system 101 can be installed on the portal 203 from within a room (e.g., classroom, office, dorm room, church) without having to traverse outside the room. As illustrated in FIG. 2, an intruder 225 with his/her arm 211 and hand 213 can reach through a broken window 209 to unlock the locking mechanism 215 so as to inwardly open the portal 203. The portal securing system 101 is configured to prevent the portal 203 from being inwardly opened irrespective of turning or unlocking the locking mechanism 215. While the portal 203 is in a closed position, the portal securing system 101 is configured with the second loop or lariat assembly 127 disposed over and secured to the locking mechanism 215, with the longitudinal element 123 disposed through the second anchor element 145 and the first loop or lariat assembly 125 being permanently or securely coupled to the coupling device 133 via the eyelet mechanism 134, with the coupling device 133 releasably coupled to the first anchor element 143. Further, the coupling device 133 is operable to releasably couple the first anchor element 143 to the locking mechanism 215 via the longitudinal element 123 so that the portal 203 is prevented from being inwardly or outwardly opened irrespective of deactivating the locking mechanism 215.

FIG. 3 illustrates a perspective view of another embodiment of a portal securing system 301 installed on an inwardly swinging portal assembly 303 having the portal 203 in accordance with various aspects as described herein. With the portal 203 configured in a closed state as shown in FIG. 3, a protruding edge 205 of the portal frame 217 is operable to stop the portal 203 when a portal strike 207 of the portal 203 engages the protruding edge 205 of the portal frame 217. While the portal 203 is in the closed position, the portal securing system 101 is configured with the second loop or lariat assembly 127 disposed over and secured to the locking mechanism 215 with the longitudinal element 123 disposed through the second anchor element 145 with the first loop or lariat assembly 125 being permanently or securely coupled to the coupling device 133 via the eyelet mechanism 134, with the coupling device 133 being releasably coupled to the first anchor element 143. Further, the coupling device 133 is operable to releasably couple the first anchor element 143 to the locking mechanism 215 via the longitudinal element 123 so that the portal 203 is prevented from being inwardly opened 305 irrespective of deactivating the locking mechanism 215.

FIG. 4 illustrates a top view of the portal securing system 301 of FIG. 3 with the inwardly swinging portal 203 being slightly ajar while secured by the portal securing system 301. In FIG. 4, the portal securing system 301 is configured to prevent the portal 203 from inwardly swinging open by the second anchor element 145 enabling the longitudinal element 121 to engage an inner edge 209 of the portal 203.

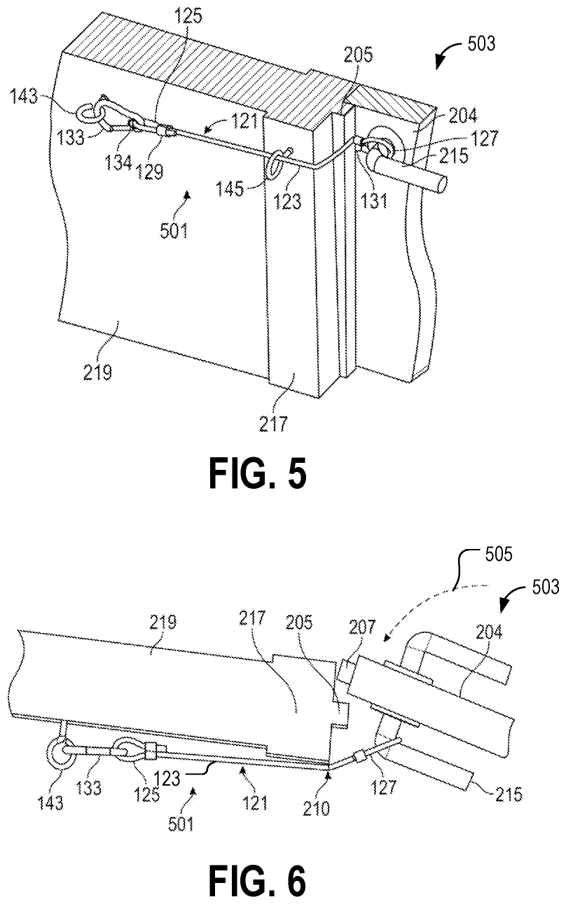

FIG. 5 illustrates a perspective view of another embodiment of a portal securing system 501 disposed on an outwardly swinging portal assembly 503 having the portal 204 in accordance with various aspects as described herein. With the portal 204 configured in a closed position relative to the portal frame 217 as shown in FIG. 5, the protruding edge 205 of the portal frame 217 is operable to stop the portal 204 when the portal strike 207 of the portal 204 engages the protruding edge 205 of the portal frame 217. While the portal 204 is in the closed position, the second loop assembly 127 is disposed over the locking mechanism 215 and the first loop assembly 125 is attached to the first anchor element 143 by the coupling device 133.

FIG. 6 illustrates a top view of the portal securing system 501 of FIG. 5 with the outwardly swinging portal 204 being slightly ajar while secured by the portal securing system 501. In FIG. 6, the portal securing system 501 is configured to prevent the portal 204 from outwardly swinging open by the second anchor element 145 enabling the longitudinal element 121 to engage the portal 203 at an outer edge 210 of the portal frame 217.

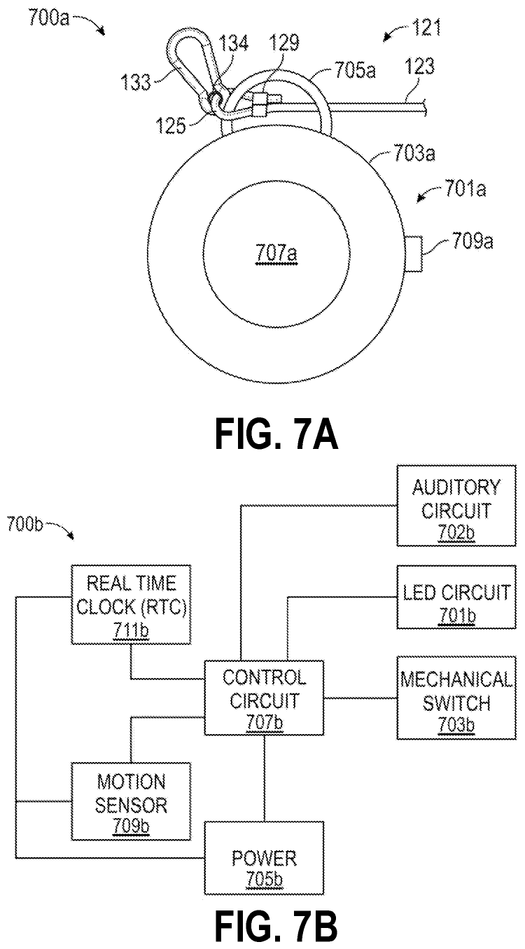

FIG. 7A illustrates one embodiment of an illumination assembly 701a coupled to the transportable component 121 of the portal securing system 700a in accordance with various aspects as described herein. In FIG. 7A, the illumination assembly 701a can include a housing 703a, a coupling mechanism 705a, a light emitting device 707a, a mechanical switch 709a, the like, or any combination thereof. The light emitting device 707a can be disposed in the housing 703a and operable to emit light so as to enable locating the transportable component 121 such as while in a poorly illuminated environment, to illuminate an area associated with the installation of the portal securing system 700a, to radiate any luminescent material disposed on the illumination assembly 701a such as on the housing 703a, the like, or any combination thereof. A luminescent material can be operable to emit light based on chemiluminescence, electroluminescence, photoluminescence (e.g., fluorescence, phosphorescence), radioluminescence, the like, or any combination thereof. At least a portion of the light emitting assembly 701a such as a portion of the housing 703a may be composed of a luminescent material that is operable to emit light. In one example, the light emitting device 707a is operable to emit light towards at least a portion of the housing 703a that is composed of a photoluminescent material. The switch 709a can be disposed on the housing 703a and operable to enable or disable the light emitting device 707a. The coupling mechanism 705a is operable to couple the illumination assembly 701a to the transportable component 121 such as to the first or second loop assembly 125, 127 or to the eyelet mechanism 134.

FIG. 7B illustrates one embodiment of an electromechanical system 700b of the illumination assembly 701a of FIG. 7A. The electromechanical system 700b can include a light emitting device circuit 701b (e.g., LED), an auditory circuit 702b (e.g., speaker), a mechanical switch 703b, power 705b (e.g., battery), a control circuit 707b, a motion sensor circuit 709b (e.g., accelerometer, gyroscope), a real time clock circuit 711b, the like, or any combination thereof. The control circuit 707b can be operable to determine that the switch 703b is on or off and in response, to enable or disable power from the power 705b to the light emitting device circuit 701b or the auditory circuit 702b. Further, the control circuit 707b can be operable to receive, from the real time clock circuit 711b, an indicator to enable or disable the light emitting device circuit 701b or the auditory circuit 702b. The real time clock circuit 711b can be operable to send indications, to the control circuit 707b, to enable for a certain time period (e.g., 60 sec.) and then disable the light emitting device circuit 701b so as to radiate with light photoluminescent material disposed on the illumination assembly 701a or the auditory circuit 702b so as to output a sound. The motion sensor circuit 709b is operable to detect any motion of the illumination assembly 701a and in response, send, to the control circuit 707b, an indication to enable or disable the light emitting device circuit 701b or the auditory circuit 702b. In operation, the illumination assembly 701a coupled to the transportable component 121 is disposed in the storage device 161 (e.g., desk drawer). The motion sensor circuit 709b detects the illumination assembly 701a and by extension the transportable component 121 being moved (e.g., desk drawer being opened) and in response, sends, to the control circuit 707b, an indication to enable power for a certain time period (e.g., 5 sec., 10 sec., 30 sec.) from the power circuit 705b to the light emitting device circuit 701b or the auditory circuit 702b so as to locate the transportable component 121 in the storage device 161.

In another embodiment, the illumination assembly 701a is configured to include a luminescence material (such as disposed on the housing 703a) that is operable to emit light so as to enable the portal securing system 700a to be located while stored in a poorly illuminated location (e.g., desk drawer). During an intruder alert at a school, classroom lights are typically turned off to reduce a likelihood that an intruder will identify a person in that classroom and as such, the classroom is poorly illuminated.

In another embodiment, the illumination assembly 701a is operable to position a viewing angle or field of view of the light emitting device 707a so as to illuminate an area or region associated with the installation of the transportable component 121 to the permanent or semi-permanent component of the portal securing system 700a.

In another embodiment, the transportable component 121 can be stored in close proximity to the portal assembly 201 such as in a box or lock box. When needed, the transportable component 121 can be withdrawn from the box and then installed to the permanent or semi-permanent component. In another embodiment, the transportable component 121 is retractable. In another embodiment, the box can be attached to the portal assembly 201. In still another embodiment, the box can have a lock such as a manual key lock or electronic lock accessible through an electronic key or card or similar device.

In another embodiment, the portal securing system 101, 301, 501, 700a is configured to include a sheath disposed about the longitudinal element 123 so as to decrease a likelihood that the longitudinal element can be severed such as by a bullet shot from a gun. The sheath can be composed of any material that is operable to deflect a bullet shot from a gun such as metal (e.g., steel), ceramic material, fiberglass material, wood, Kevlar™, polyethylene material, polycarbonate material, acrylic material, graphene, the like, or any combination thereof.

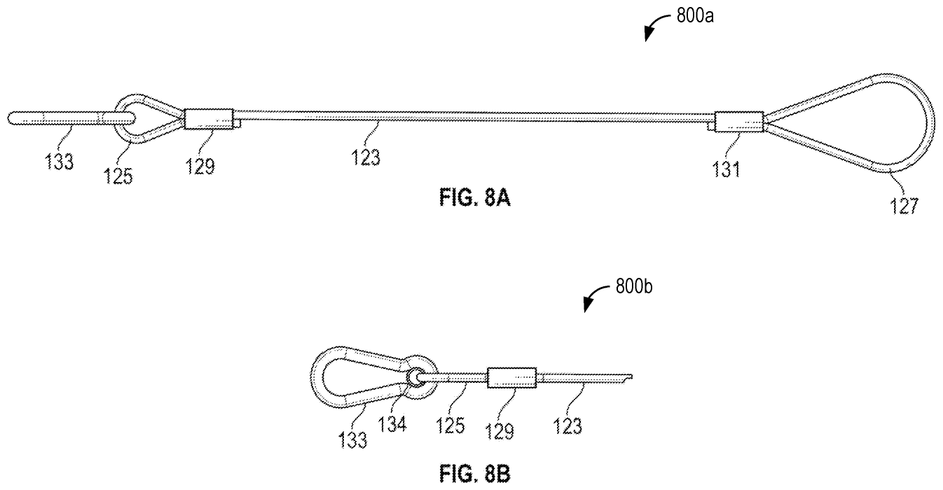

FIGS. 8A-B illustrate another embodiment of a transportable component 800a,b in accordance with various aspects as described herein. In FIGS. 8A-B, the transportable component 800a,b includes the longitudinal element 123 having the loop or lariat assemblies 125, 127 formed at each end of the longitudinal element 123. The coupling device 133 (e.g., carabineer) is configured to include an eyelet mechanism 134 that enables the coupling device 133 to be securely coupled to the loop or lariat assembly 125 so that the coupling device 133 is permanently or securely coupled to the longitudinal element 123. Each loop or lariat assembly 125, 127 can be configured by forming a loop or lariat with an end portion of the longitudinal element 123 and then securely attaching a fastener element 129, 131 about a base of each loop or lariat assembly 125, 127 to secure the loop or lariat of that end portion to the longitudinal element 123. As shown in FIGS. 8A-B, the effective radius of the second loop or lariat assembly 127 can be greater than the effective radius of the first loop or lariat assembly 125 so that the second loop or lariat assembly 127 is adaptable to be positioned about and releasably coupled to any locking mechanism 215 or similar protrusion disposed on the portal 203.

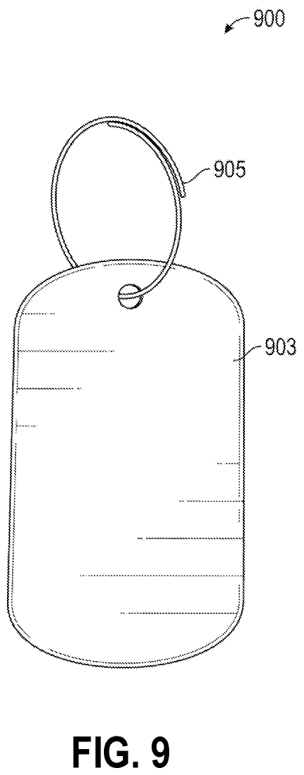

FIG. 9 illustrates another embodiment of an illumination assembly 900 in accordance with various aspects as described herein. The illumination assembly 900 is configured to include a luminescence component 903 that is operable to emit light so as to enable the portal securing system 101 to be located while stored in a poorly illuminated location (e.g., desk drawer, briefcase, bag). In one example, the front, back, or both of the luminescence component 903 is operable to emit light. During an intruder alert at a school, classroom lights are typically turned off and as such, the classroom is poorly illuminated. Further, the illumination assembly 900 includes a coupling mechanism 905 operable to couple the illumination assembly 900 to the transportable component 121 such as to the first or second loop assembly 125, 127 or to the eyelet mechanism 134.

Additional embodiments will now be described. At least some of these embodiments may be described as applicable in certain contexts for illustrative purposes, but the embodiments are similarly applicable in other contexts not explicitly described.

In one exemplary embodiment, a portal securing system includes a permanent or semi-permanent component having at least one anchor element, with each anchor element being configured to securely couple to a wall or frame associated with a portal; a transportable component having a longitudinal element coupled to a coupling mechanism, with the transportable component having at least a certain minimum breaking load, the longitudinal element having first and second ends with each end having a loop or lariat assembly, with the coupling mechanism having an eyelet element that defines a circular or ovular aperture, the loop or lariat assembly of the first end being disposed through the circular or ovular aperture of the eyelet element of the coupling mechanism such that the coupling mechanism and the longitudinal element are securely coupled; and wherein the portal securing system is operable to prevent the portal from being opened while the transportable component is releasably coupled between the permanent or semi-permanent component and the locking mechanism of the portal.

In another exemplary embodiment, the system further includes an illumination assembly coupled to the transportable component and operable to emit light to enable locating the transportable component and to enable illuminating an area associated with coupling the transportable component to the permanent or semi-permanent component and a locking mechanism of the portal.

In another exemplary embodiment, the illumination assembly includes a light emitting device operable to emit light to enable the illumination of the area associated with coupling the transportable component to the permanent or semi-permanent component and the locking mechanism of the portal.

In another exemplary embodiment, the illumination assembly includes a motion sensor circuit, a control circuit, and a light emitting device, with the motion sensor circuit being operable to detect movement associated with the transportable component and in response, send, to the control circuit, an indication of that motion, the control circuit being operable to receive, from the motion sensor circuit, the motion indication, and in response, to enable power to the light emitting device.

In another exemplary embodiment, the illumination assembly includes a photoluminescent material that is operable to emit light.

In another exemplary embodiment, a sheath is disposed about the longitudinal element to enable further protection of the longitudinal element from being severed.

In another exemplary embodiment, at least one anchor element is positioned on the wall or the portal frame between another anchor element and a locking mechanism of the portal.

In another exemplary embodiment, at least one anchor element has a vertical height, relative to a floor associated with the portal, that is the same vertical height as a locking mechanism of the portal.

In another exemplary embodiment, at least one anchor element has a vertical height, relative to a floor surface associated with the portal, that is below a vertical height of another anchor element and a vertical height of a locking mechanism of the portal.

In another exemplary embodiment, an effective radius of the loop or lariat assembly at the second end of the longitudinal element is greater than an effective radius of the loop or lariat assembly at the first end of the longitudinal element.

In another exemplary embodiment, the loop or lariat assembly of the second end of the longitudinal element is adaptable to be positioned about and releasably coupled to the locking mechanism of the portal.

In another exemplary embodiment, the permanent or semi-permanent component includes first and second anchor elements securely coupled to the wall or frame associated with the portal, with the second anchor element being disposed between the first anchor element and the locking mechanism of the portal.

In another exemplary embodiment, the first and second anchor elements and the locking mechanism of the portal being a same vertical height relative to a floor surface associated with the portal.

In another exemplary embodiment, the second anchor element is positioned about equidistant between the first anchor element and the locking mechanism of the portal while the portal is closed.

In another exemplary embodiment, the second anchor element is positioned about half a length of the longitudinal element from the first anchor element.

In another exemplary embodiment, the certain minimum breaking load of the longitudinal element is at least one hundred MegaPascals (100 MPa).

In one exemplary embodiment, method includes, by a control circuit of an illumination assembly coupled to a transportable component of a portal securing system, with the control circuit being operationally coupled to a motion sensor circuit and a light emitting device circuit of the illumination assembly, with the motion circuit being operable to detect motion of the illumination assembly and the light emitting device circuit being operable to emit light, the transportable component having a longitudinal element coupled to a coupling mechanism, with the transportable component having at least a certain minimum breaking load, the longitudinal element having first and second ends with each end having a loop or lariat assembly, with an effective radius of the loop or lariat assembly at the second end of the longitudinal element being greater than an effective radius of the loop or lariat assembly at the first end of the longitudinal element and the loop or lariat assembly of the second end of the longitudinal element being adaptable to be positioned about and releasably coupled to the locking mechanism of the portal, with the coupling mechanism having an eyelet element that defines a circular or ovular aperture, the loop or lariat assembly of the first end being disposed through the circular or ovular aperture of the eyelet element of the coupling mechanism such that the coupling mechanism and the longitudinal element are securely coupled, receiving, from the motion sensor circuit, an indication associated with motion of the illumination assembly; determining to illuminate the light emitting device responsive to determining that the illumination assembly is moving based on the motion indication; and sending, to the light emitting device circuit, an indication to enable illumination by the light emitting device circuit so that the transportable component can be located based on the illumination.

In another exemplary embodiment, the illumination assembly includes a real time clock circuit operationally coupled to the control circuit; and wherein in the method further includes: receiving, from the real time clock circuit, an indication associated with disabling the illumination by the light emitting device circuit; determining to disable the illumination by the light emitting device circuit; and sending, to the light emitting device circuit, an indication to disable the illumination.

In another exemplary embodiment, the method further includes determining to illuminate the light emitting device for a certain time period responsive to receiving the motion indication; and sending, to the real time clock circuit, an indication that includes a request to send the indication associated with disabling the illumination by the light emitting device circuit after the certain time period.

In one exemplary embodiment, a transportable component device includes a coupling mechanism having an eyelet element that defines a circular or ovular aperture; a longitudinal element having first and second ends with each end having a loop or lariat assembly, with an effective radius of the loop or lariat assembly at the second end of the longitudinal element being greater than an effective radius of the loop or lariat assembly at the first end of the longitudinal element and the loop or lariat assembly of the second end of the longitudinal element being adaptable to be positioned about and releasably coupled to the locking mechanism of the portal, the loop or lariat assembly of the first end being disposed through the circular or ovular aperture of the eyelet element of the coupling mechanism such that the coupling mechanism and the longitudinal element are securely coupled; an illumination assembly operable to emit light to enable locating the transportable component and to enable illumination of an area associated with coupling the transportable component to the permanent or semi-permanent component and to a locking mechanism of the portal; and wherein the portal securing system is operable to prevent the portal from being opened while the transportable component is releasably coupled between the permanent or semi-permanent component and the locking mechanism of the portal.

The previous detailed description is merely illustrative in nature and is not intended to limit the present disclosure, or the application and uses of the present disclosure. Furthermore, there is no intention to be bound by any expressed or implied theory presented in the preceding field of use, background, summary, or detailed description. The present disclosure provides various examples, embodiments and the like, which may be described herein in terms of functional or logical block elements. The various aspects described herein are presented as methods, devices (or apparatus), systems, or articles of manufacture that may include a number of components, elements, members, modules, nodes, peripherals, or the like. Further, these methods, devices, systems, or articles of manufacture may include or not include additional components, elements, members, modules, nodes, peripherals, or the like.

Furthermore, the various aspects described herein may be implemented using standard programming or engineering techniques to produce software, firmware, hardware (e.g., circuits), or any combination thereof to control a computing device to implement the disclosed subject matter. It will be appreciated that some embodiments may be comprised of one or more generic or specialized processors such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods, devices and systems described herein. Alternatively, some or all functions could be implemented by a state machine that has no stored program instructions, or in one or more application specific integrated circuits (ASICs), in which each function or some combinations of certain of the functions are implemented as custom logic circuits. Of course, a combination of the two approaches may be used. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The term “article of manufacture” as used herein is intended to encompass a computer program accessible from any computing device, carrier, or media. For example, a computer-readable medium may include: a magnetic storage device such as a hard disk, a floppy disk or a magnetic strip; an optical disk such as a compact disk (CD) or digital versatile disk (DVD); a smart card; and a flash memory device such as a card, stick or key drive. Additionally, it should be appreciated that a carrier wave may be employed to carry computer-readable electronic data including those used in transmitting and receiving electronic data such as electronic mail (e-mail) or in accessing a computer network such as the Internet or a local area network (LAN). Of course, a person of ordinary skill in the art will recognize many modifications may be made to this configuration without departing from the scope or spirit of the subject matter of this disclosure.

Throughout the specification and the embodiments, the following terms take at least the meanings explicitly associated herein, unless the context clearly dictates otherwise. Relational terms such as “first” and “second,” and the like may be used solely to distinguish one entity or action from another entity or action without necessarily requiring or implying any actual such relationship or order between such entities or actions. The term “or” is intended to mean an inclusive “or” unless specified otherwise or clear from the context to be directed to an exclusive form. Further, the terms “a,” “an,” and “the” are intended to mean one or more unless specified otherwise or clear from the context to be directed to a singular form. The term “include” and its various forms are intended to mean including but not limited to. References to “one embodiment,” “an embodiment,” “example embodiment,” “various embodiments,” and other like terms indicate that the embodiments of the disclosed technology so described may include a particular function, feature, structure, or characteristic, but not every embodiment necessarily includes the particular function, feature, structure, or characteristic. Further, repeated use of the phrase “in one embodiment” does not necessarily refer to the same embodiment, although it may. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed.

What is claimed is:

1. A portal securing system, comprising:
a permanent or semi-permanent component having at least one anchor element, with each anchor element being configured to securely couple to a wall or frame associated with a portal;
a transportable component having a longitudinal element coupled to a coupling mechanism, with the transportable component having at least a certain minimum breaking load, the longitudinal element having first and second ends with each end having a loop or lariat assembly, with the coupling mechanism having an eyelet element that defines a circular or ovular aperture, the loop or lariat assembly of the first end being disposed through the circular or ovular aperture of the eyelet element of the coupling mechanism such that the coupling mechanism and the longitudinal element are securely coupled; and
wherein the portal securing system is operable to prevent the portal from being opened while the transportable component is releasably coupled between the permanent or semi-permanent component and a locking mechanism of the portal.

2. The system of claim 1, further comprising:
an illumination assembly coupled to the transportable component and operable to emit light to enable locating the transportable component and to enable illumination of an area or region associated with coupling the transportable component to the permanent or semi-permanent component and the locking mechanism of the portal.

3. The system of claim 2, wherein the illumination assembly includes a light emitting device operable to emit light to enable the illumination of the area or region associated with coupling the transportable component to the permanent or semi-permanent component and the locking mechanism of the portal.

4. The system of claim 2, wherein the illumination assembly includes a motion sensor circuit, a control circuit, and a light emitting device, with the motion sensor circuit being operable to detect movement associated with the transportable component and in response, send, to the control circuit, an indication of that motion, the control circuit being operable to receive, from the motion sensor circuit, the motion indication, and in response, to enable power to the light emitting device.

5. The system of claim 2, wherein the illumination assembly includes a photoluminescent material that is operable to emit light.

6. The system of claim 1, wherein a sheath is disposed about the longitudinal element to enable further protection of the longitudinal element from being severed.

7. The system of claim 1, wherein at least one anchor element is positioned on the wall or the portal frame between another anchor element and the locking mechanism of the portal.

8. The system of claim 1, wherein at least one anchor element has a vertical height, relative to a floor associated with the portal, that is the same vertical height as the locking mechanism of the portal.

9. The system of claim 1, wherein at least one anchor element has a vertical height, relative to a floor surface associated with the portal, that is below a vertical height of another anchor element and a vertical height of the locking mechanism of the portal.

10. The system of claim 1, wherein an effective radius of the loop or lariat assembly at the second end of the longitudinal element is greater than an effective radius of the loop or lariat assembly at the first end of the longitudinal element.

11. The system of claim 10, wherein the loop or lariat assembly of the second end of the longitudinal element is adaptable to be positioned about and releasably coupled to the locking mechanism of the portal.

12. The system of claim 1, wherein the permanent or semi-permanent component includes first and second anchor elements securely coupled to the wall or frame associated with the portal, with the second anchor element being disposed between the first anchor element and the locking mechanism of the portal.

13. The system of claim 12, wherein the first and second anchor elements and the locking mechanism of the portal being a same vertical height relative to a floor surface associated with the portal.

14. The system of claim 12, wherein the second anchor element is positioned about equidistant between the first anchor element and the locking mechanism of the portal while the portal is closed.

15. The system of claim 12, wherein the second anchor element is positioned about half a length of the longitudinal element from the first anchor element.

16. The system of claim 1, wherein the certain minimum breaking load of the longitudinal element is at least one hundred MegaPascals (100 MPa).

17. A method, comprising:
by a control circuit of an illumination assembly coupled to a transportable component of a portal securing system, with the control circuit being operationally coupled to a motion sensor circuit and a light emitting device circuit of the illumination assembly, with the motion circuit being operable to detect motion of the illumination assembly and the light emitting device circuit being operable to emit light, the transportable component having a longitudinal element coupled to a coupling mechanism, with the transportable component having at least a certain minimum breaking load, the longitudinal element having first and second ends with each end having a loop or lariat assembly, with an effective radius of the loop or lariat assembly at the second end of the longitudinal element being greater than an effective radius of the loop or lariat assembly at the first end of the longitudinal element and the loop or lariat assembly of the second end of the longitudinal element being adaptable to be positioned about and releasably coupled to a locking mechanism of the portal, with the coupling mechanism having an eyelet element that defines a circular or ovular aperture, the loop or lariat assembly of the first end being disposed through the circular or ovular aperture of the eyelet element of the coupling mechanism such that the coupling mechanism and the longitudinal element are securely coupled,
receiving, from the motion sensor circuit, an indication associated with detection of motion associated with the illumination assembly;
determining to illuminate the light emitting device responsive to determining that the illumination assembly is moving based on the motion indication; and
sending, to the light emitting device circuit, an indication to enable illumination by the light emitting device circuit so that the transportable component can be located based on the illumination.

18. The method of claim 17, wherein the illumination assembly includes a real time clock circuit operationally coupled to the control circuit; and
wherein in the method further includes:
receiving, from the real time clock circuit, an indication associated with disabling the illumination by the light emitting device circuit;
determining to disable the illumination by the light emitting device circuit; and
sending, to the light emitting device circuit, an indication to disable the illumination.

19. The method of claim 18, further comprising:
determining to illuminate the light emitting device for a certain time period responsive to receiving the motion indication; and
sending, to the real time clock circuit, an indication that includes a request to send the indication associated with disabling the illumination by the light emitting device circuit after the certain time period.

20. A transportable component device, comprising:
a coupling mechanism having an eyelet element that defines a circular or ovular aperture;
a longitudinal element having first and second ends with each end having a loop or lariat assembly, with an effective radius of the loop or lariat assembly at the second end of the longitudinal element being greater than an effective radius of the loop or lariat assembly at the first end of the longitudinal element and the loop or lariat assembly of the second end of the longitudinal element being adaptable to be positioned about and releasably coupled to a locking mechanism of a portal, the loop or lariat assembly of the first end being disposed through the circular or ovular aperture of the eyelet element of the coupling mechanism such that the coupling mechanism and the longitudinal element are securely coupled;
an illumination assembly operable to emit light to enable locating the transportable component and to enable illumination of an area associated with coupling the transportable component to the permanent or semi-permanent component and to the locking mechanism of the portal; and
wherein the portal securing system is operable to prevent the portal from being opened while the transportable component is releasably coupled between the permanent or semi-permanent component and the locking mechanism of the portal.
